(19) United States
(12) Patent Application Publication
(10) Pub. No.: US 2011/0252007 A1
(43) Pub. Date: Oct. 13, 2011

(54) METHOD OF STORING DATA IN STORAGE MEDIA, DATA STORAGE DEVICE USING THE SAME, AND SYSTEM INCLUDING THE SAME

(75) Inventors: Kyoung Lae CHO, Yongin-si (KR); Bumseok Yu, Suwon-si (KR); Junjin Kong, Yongin-si (KR); Hee Chang Cho, Seoul (KR); Seongsik Hwang, Seoul (KR)

(73) Assignee: Samsung Electronics Co., Ltd., Suwon-si (KR)

(21) Appl. No.: 13/082,694

(22) Filed: Apr. 8, 2011

(30) Foreign Application Priority Data
Apr. 9, 2010 (KR) 10-2010-0032804

(51) Int. Cl. G06F 17/30

(52) U.S. Cl. 707/693; 707/E17.002

(57) ABSTRACT

A method of storing data in a storage media includes compressing raw data based on a physical storage unit of the storage media and storing the compressed data in the storage media. The physical storage unit of the storage media storing the compressed data includes an update region into which update data may be written.

### CROSS-REFERENCE TO RELATED APPLICATIONS

This application claims the benefit to priority, under 35 U.S.0 §119, of Korean Patent Application No. 10-2010-0032804 filed Apr. 9, 2010, the entirety of which is incorporated by reference herein.

### BACKGROUND

1. Field of the Invention

The present general inventive concept relates to electronic devices, and more particularly, the present general inventive concept relates to a data storage device.

2. Description of the Related Art

As it is known in the art, computer systems generally use several types of memory systems. For example, computer systems generally use so called main memory comprised of semiconductor devices typically having the attribute that the devices can be randomly written to and read from with comparable and very fast access times and thus are commonly referred to as random access memories (RAM). However, since semiconductor memories are relatively expensive, other higher density and lower cost memories are often used. For example, other memory systems include magnetic disk storage systems. In case of magnetic disk storage systems, generally, access times are in the order of tens of milliseconds. On the other hand, in case of main memory, the access times are in the order of hundreds of nanoseconds. Disk storage is used to store large quantities of data which can be sequentially read into main memory as needed. Another type of disk-like storage is solid state disk storage (SSD, also called solid state drive). SSD is a data storage device that uses memory chips, such as SDRAM, to store data, instead of the spinning platters found in conventional hard disk drives.

The term “SSD” is used for two different kinds of products. The first type of SSD, based on fast, volatile memory such as SDRAM, is categorized by extremely fast data access and is used primarily to accelerate applications that are held back by the latency of disk drives. Since this SSD uses volatile memory, it typically incorporates internal battery and backup disk systems to ensure data persistence. If power is lost for whatever reason, the battery keeps the unit powered long enough to copy all data from RAM to backup disk. Upon the restoration of power, data is copied back from backup disk to RAM and the SSD resumes normal operation. The first type of SSD is especially useful on a computer which is already has the maximum amount of RAM. The second type of SSD uses flash memory to store data and is generally used as a replacement of a hard disk drive.

### SUMMARY

The present general inventive concept is directed to methods and apparatuses to store data in a storage media by compressing data according to physical space in the storage media, and maintaining an update region in the compressed data.

Additional aspects and utilities of the present general inventive concept will be set forth in part in the description which follows and, in part, will be obvious from the description, or may be learned by practice of the present general inventive concept.

Utilities of the present general inventive concept may be realized by a method of storing data in a storage media, the method including compressing raw data based on a physical storage unit of the storage media, and storing the compressed data in the storage media, wherein the physical storage unit of the storage media storing the compressed data includes an update region.

Utilities of the present general inventive concept may also be realized by a data storage device including a storage media, and a controller configured to compress data to be stored in the storage media by a compression unit. The controller may control the compression unit so that an update region exists within a physical storage unit of the storage media in which the compressed data is stored.

Utilities of the present general inventive concept may also be realized by a system which includes a plurality of solid state drives, wherein each of the solid state drives comprises a storage media, and a controller configured to compress data to be stored in the storage media by a compression unit, the controller controlling the compression unit so that an update region exists within a physical storage unit of the storage media in which the compressed data is stored.

Features and/or utilities of the present general inventive concept may also be realized by a method of storing data including detecting a predetermined storage unit of a data storage device, the predetermined storage unit being a segment of data storage of a predetermined size of the data storage device, determining a compression unit, the compression unit being a predetermined size of compressed data, and adjusting a size of the compression unit according to a reference condition including a size of the predetermined storage unit of the data storage device.

The reference condition may include a determination whether the compression unit corresponds to a predetermined percentage of the predetermined storage unit less than 100%.

The reference condition may include a determination whether the predetermined storage unit is of a sufficient size to include an update region having a predetermined size in addition to the compression unit.

The method may further include receiving streamed data, compressing the streamed data in increments of the compression unit, and storing the compression units of compressed data in respective predetermined storage units of the data storage device such that each of the predetermined units may include an update region to receive additional data.

The method may further include, after storing the compressed data in the predetermined storage units, receiving an update request to store additional data in at least one predetermined storage unit including the compressed data, determining whether a size of update data to be stored in the at least one predetermined storage unit in an update operation is equal to or less than a size of the update region of the at least one predetermined storage unit, and storing the update data in the update region of the at least one predetermined storage unit when it is determined that the size of the update data to be stored in the at least one predetermined storage unit is equal to or less than the size of the update region of the at least one predetermined storage unit.

The method may further include storing the compressed data of the at least one predetermined storage unit and the update data in at least a plurality of predetermined storage units having a storage capacity greater than the at least one predetermined storage unit when it is determined that the size of the update data to be stored in the at least one predetermined storage unit is greater than the update region of the at least one predetermined storage unit.

Features and/or utilities of the present general inventive concept may also be realized by a data storage unit including a data storage device to store data in increments of predetermined storage units, a compression device to receive data and to compress the data in increments of compression units, and a CPU to control the compression device to adjust a size of the compression units based on at least one reference condition including a size of the predetermined storage units.

The reference condition may include a determination whether the predetermined storage unit is of a sufficient size to include an update region having a predetermined size in addition to the compression unit.

The CPU may control the compression device to compress streamed data in increments of the compression unit and to transmit the compressed data to the data storage device, and the data storage device may store the compressed data in units of compression units in respective predetermined storage units.

The CPU may receive an update request to store additional data in at least one predetermined storage unit including the compressed data, the CPU may determine whether a size of update data to be stored in the at least one predetermined storage unit in an update operation is equal to or less than a size of the update region of the at least one predetermined storage unit, and the data storage device may store the update data in the update region of the at least one predetermined storage unit when it is determined that the size of the update data to be stored in the at least one predetermined storage unit is equal to or less than the size of the update region of the at least one predetermined storage unit.

The data storage device may store the compressed data of the at least one predetermined storage unit and the update data in at least a plurality of predetermined storage units having a storage capacity greater than the at least one predetermined storage unit when it is determined that the size of the update data to be stored in the at least one predetermined storage unit is greater than the update region of the at least one predetermined storage unit.

### BRIEF DESCRIPTION OF THE DRAWINGS

The above and other objects and features of the present general inventive concept will become apparent from the following description with reference to the following figures, wherein like reference numerals refer to like parts throughout the various figures unless otherwise specified, and wherein:

FIG. 1 is a block diagram showing a data storage device according to an exemplary embodiment of the present general inventive concept.

FIG. 2 is a block diagram showing a controller illustrated in FIG. 1 according to an exemplary embodiment of the present general inventive concept.

FIG. 3 is a flow chart for describing a write operation of a data storage device according to an exemplary embodiment of the present general inventive concept.

FIG. 4 is a block diagram showing an overall write flow of a data storage device according to an exemplary embodiment of the present general inventive concept.

FIGS. 5A and 5B illustrate an update operation of a data storage device in which compressed data is stored.

FIG. 6 is a block diagram showing a data storage device according to another exemplary embodiment of the present general inventive concept.

FIGS. 7 and 8 are block diagrams showing systems to which a data storage device according to an exemplary embodiment of the present general inventive concept is applied.

FIG. 9 is a block diagram showing a solid state drive (SSD) to which a compression manner according to exemplary embodiments of the present general inventive concept is applied.

FIG. 10 is a block diagram showing a storage using an SSD illustrated in FIG. 9.

FIG. 11 is a block diagram showing a storage server using an SSD illustrated in FIG. 15.

FIG. 12 is a block diagram showing a storage according to another exemplary embodiment of the present general inventive concept.

FIG. 13 is a block diagram showing a storage server using a storage in FIG. 12.

FIGS. 14 to 16 are diagrams showing systems to which a data storage device according to exemplary embodiments of the present general inventive concept is applied.

### DETAILED DESCRIPTION OF THE EMBODIMENTS

The present general inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, operations, operations, elements, and/or components, but do not preclude the presence or addition of one or more other features, integers, operations, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

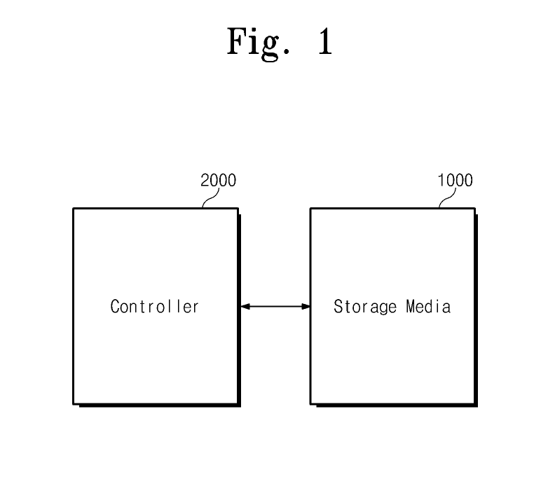

FIG. 1 is a block diagram showing a data storage device according to an exemplary embodiment of the inventive concept.

Referring to FIG. 1, a data storage system includes a storage media 1000 and a controller 2000. The storage media 1000 is used to store data information having various types such as texts, graphics, software codes, and the like. The storage media 1000, for example, is formed of a non-volatile memory such as PRAM, FeRAM, MRAM, or the like. But, it is well understood that non-volatile memories applied to the storage media 1000 are not limited to this disclosure. The controller 2000 is configured to control the storage media 1000 in response to external requests. The controller 2000 is configured to compress data from an external device and to store the compressed data in the storage media 1000. The data compressing manner enables the storage media 1000 to be used effectively. For example, the storage media 1000 stores a large amount of data with low cost. Further, with the data compressing manner, it is possible to reduce the amount of data transferred between the storage media 1000 and the controller 2000. That is, with the data compressing manner, there is reduced a transfer time taken to transfer data between the storage media 1000 and the controller 2000.

In an exemplary embodiment, the controller 2000 is configured to adjust a compression unit (or, a division unit) of data provided from an external. Herein, the compression unit may correspond to a physical storage unit LWU of the storage media 1000. In particular, the compression unit may be determined such that after compressed data is stored, a free/remaining space (or, an update space) exists at a physical storage unit LWU of the storage media 1000. The compression rate of compressed data may be different according to characteristics of raw data (or, stream data) provided from an external device. For this reason, the compression unit may be controlled variably to provide a physical storage unit LWU of the storage media 1000 with a free/remaining space (or, an update space). The free/remaining/update space may be used to update data in a corresponding physical storage unit. This enables unnecessary operations (for example, generation of unused blocks, a merge operation, etc.) due to update request to be prevented.

In an exemplary embodiment, the physical storage unit of the storage media 1000 may be set to a block unit, a super-block unit, or the like of a non-volatile memory which is applied to the storage media 1000. In the event that a non-volatile memory has an M-plane array structure (M being an integer of 2 or more), the super-block is formed of N memory blocks in each of M planes and in the same row. N may be an integer less than M, and N may be greater than 1. Further, the physical storage unit (or, a compression/division unit) may be formed of a plurality of blocks in the same plane.

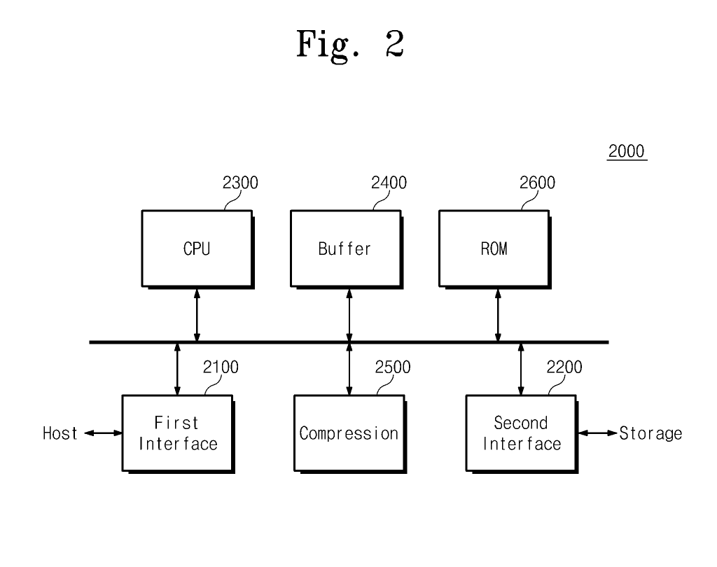

FIG. 2 is a block diagram showing a controller illustrated in FIG. 1 according to an exemplary embodiment of the inventive concept.

Referring to FIG. 2, a controller 2000 comprises the first interface 2100, the second interface 2200, CPU 2300 being a processing unit, a buffer 2400, a compression block 2500, and ROM 2600.

The first interface 2100 is configured to interface with an external device (e.g., a host). The second interface 2200 is configured to interface with a storage media 1000 illustrated in FIG. 1. As a processing unit, the CPU 2300 is configured to control an overall operation of the controller 2000. For example, the CPU 2300 is configured to execute firmware such as a memory translation layer (MTL) stored in the ROM 2600. As will be described, the MTL is used to manage memory mapping information and a division/compression unit of stream data. But, a role of the MTL is not limited to this disclosure. For example, the MTL is used to manage wear-leveling, bad blocks, data retention caused due to unexpected power interruption, and the like.

The buffer 2400 is used to temporarily store data transferred from an external device via the first interface 2100. The buffer 2400 is used to temporarily store data transferred from the storage media 1000 via the second interface 2200. The compression block 2500 operates responsive to the control of the CPU 2300 (or, the control of MTL executed by the CPU 2300) and is configured to compress data sequentially provided from the buffer 2400 by a division unit. Each of compressed data is stored in the storage media 1000 via the second interface 2200. The compression block 2500 is configured to compress data, transferred by a compression unit, in whole or in a page unit. Further, the compression block 2500 operates responsive to the control of the CPU 2300 (or, the control of MTL executed by the CPU 2300) and is configured to decompress data read out from the storage media 1000.

In an exemplary embodiment, a compression function of the compression block 2500 may be made optionally/selectively. In this case, stream data is stored in the storage media 1000 via the buffer 2400 without data compression. For example, a determination as to whether the compression block 2500 is turned ON or OFF may be made according to received stream data. If multimedia data being compressed data is provided to a data storage device or if a relatively large amount of energy is consumed during data compression due to a remarkably small size of data, the compression block 3500 may be set to an OFF state. The compression block 2500 may be turned ON or OFF by hardware (for example, a physical register) or by a software setting. Unlike the above description, externally provided data is able to be stored directly in the storage media 1000 via the first and second interfaces 2100 and 2200 without passing through the buffer 2400.

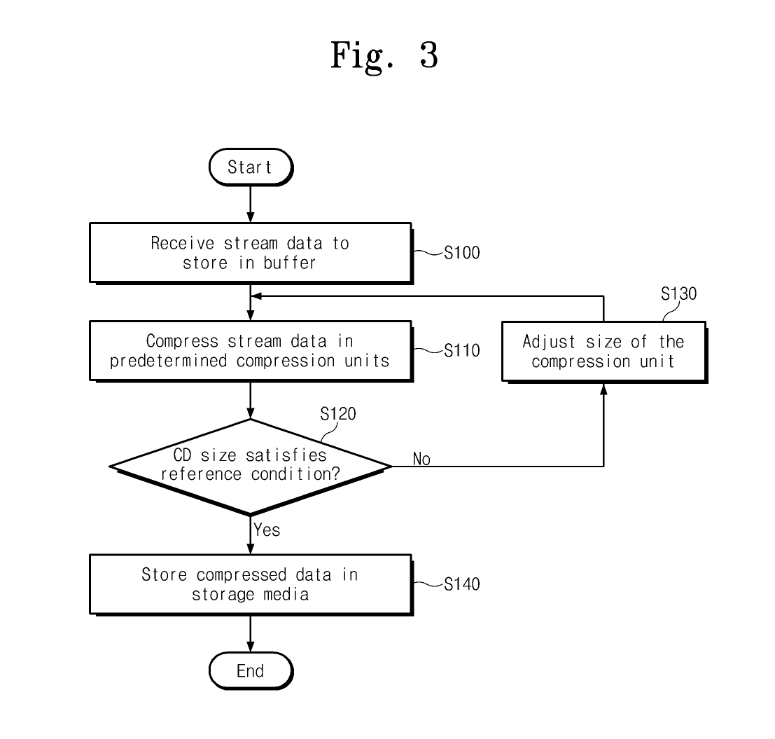

FIG. 3 is a flow chart for describing a write operation of a data storage device according to an exemplary embodiment of the present general inventive concept. Below, a write operation of a data storage device according to an exemplary embodiment of the present general inventive concept will be more fully described with reference to accompanying drawings.

In operation S100, stream data externally provided upon write request is stored in a buffer 2400 via a first interface 2100 under the control of CPU 2300. In operation S110, the stream data stored in the buffer 2400 is compressed by the compression block 2500 before being stored in a storage media 1000. The stream data may be compressed in predetermined increments that may be referred to as “compression units” or “division units.” For example, the stream data in the buffer 2400 may be divided into a plurality of sub-groups and each sub-group may be the size of the predetermined division unit or compression unit. Data of each sub-group may be compressed by the compression block 2500.

In operation S120, the CPU 2300, or a Memory Translation Layer (MTL) executed by the CPU 2300, judges whether a size of the compressed data (CD) satisfies a reference condition. The reference condition may be determined according to a physical storage unit LWU of a storage media 1000. For example, the reference condition may include determining whether, after compressed data CD is stored in a physical storage unit LWU of the storage media 1000, the physical storage unit LWU has a free/update/remaining space. Alternatively, the reference condition may include determining whether a size of compressed data is identical to or less than (physical storage-a) (for example, 70% to 80% of the physical data storage). If a size of the compressed data (CD) is judged not to satisfy a reference condition, the procedure goes to operation S130, in which the size of the compression unit is adjusted. This may be accomplished according to the control of the MTL or the compression block 2500. For example, if it is determined that the compressed data CD is too large, so that there would not be sufficient space in a physical storage unit in which the compression data CD is stored to include an update space, then the size of the compression unit may be decreased. Afterwards, the procedure goes to the operation S110. The operations S110 to S130 are repeated until a size of the compressed data (CD) satisfies the reference condition.

Returning to operation S120, if a size of the compressed data (CD) is judged to satisfy the reference condition, the procedure goes to operation S140, in which compressed data is stored in the storage media 1000. Afterwards, the procedure is ended.

Determining that a size of the compressed data (CD) satisfies a reference condition means that a physical storage unit LWU has a free/update/remaining space after compressed data is stored therein. The free/update/remaining space is used when a request is received to update data stored in a physical storage unit LWU. An update may be made to store data in the update region when a size of the update data is within a range that does not exceed a size of the update region of the physical storage unit LWU. If the amount of data to be updated exceeds a size of the update region, data stored in an update-requested physical storage unit and data to be updated may be stored in a new storage region.

As understood from the above description, it is possible to prevent unnecessary operations (e.g., generation of unused blocks, a merge operation, etc.) when an update request is received by controlling a size of a compression unit such that an update/free/remaining space exists in a physical storage unit that includes the compressed data.

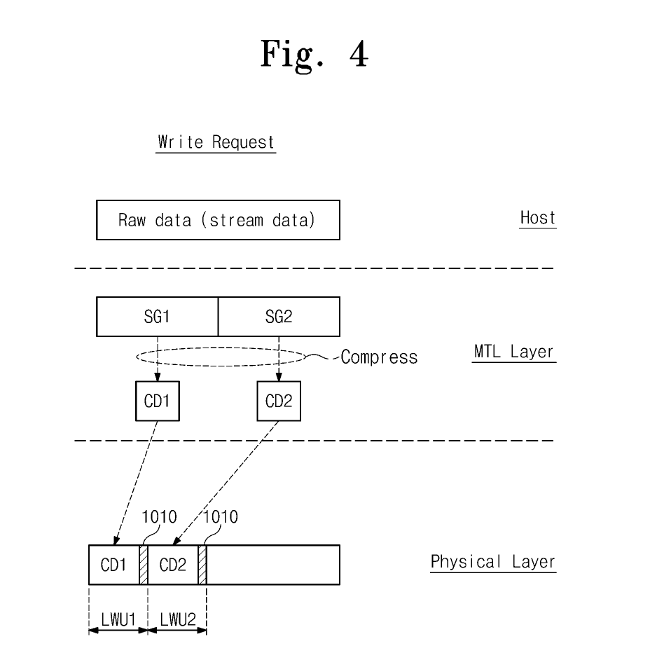

FIG. 4 is a block diagram showing an overall write flow of a data storage device according to an exemplary embodiment of the present general inventive concept.

Referring to FIG. 4, a memory translation layer MTL may divide write-requested data into a plurality of sub-groups (for example, SG1 and SG2) according to a manner described in FIG. 3, and a compression block 2500 may compress the sub-groups SG1 and SG2, respectively, to generate compressed data CD1 and CD2, respectively. Herein, data division may be made in increments of compression units that may be determined variably as described in FIG. 3. If the compression unit is determined, compressed data CD1 and CD2 of the sub-groups SG1 and SG2 may be stored in corresponding physical storage units LWU1 and LWU2 of a storage media 1000. As illustrated in FIG. 4, after compressed data CD1 and CD2 of the sub-groups SG1 and SG2 are stored in corresponding physical storage units LWU1 and LWU2 of the storage media 1000, the units LWU1 and LWU2 still have an update/free/remaining region 1010, respectively. The region 1010 is used to store update data provided upon update request to a corresponding physical storage unit.

In an exemplary embodiment, a part of functions (for example, a function of determining a division size) of the MTL may be made at a host level. In this case, information indicating a division size (or, a compression size) is provided to a data storage device together with stream data, and the data storage device performs a compression function according to the externally provided information (that is, a division size). Alternatively, it is possible to transfer data to the data storage device based on a division size (or, a compression size) determined at a host level.

In an exemplary embodiment, a physical storage unit LWU is formed of a writable unit WU or a plurality of writable units. For example, the physical storage unit LWU may be set to a block, a super-block, M blocks (M being 2 or more integer), or M super-blocks. The writable unit WU indicates a unit by which memory cells are programmed at the same time. The writable unit WU, for example, includes a word, a page, a plurality of sectors, etc.

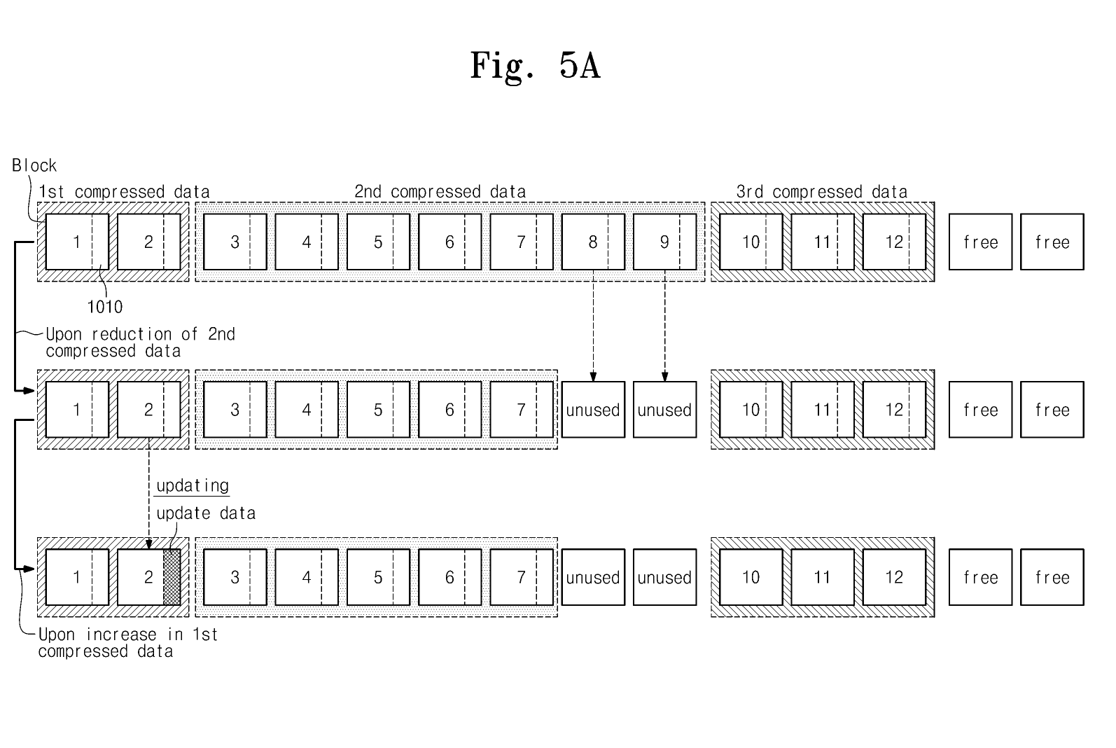

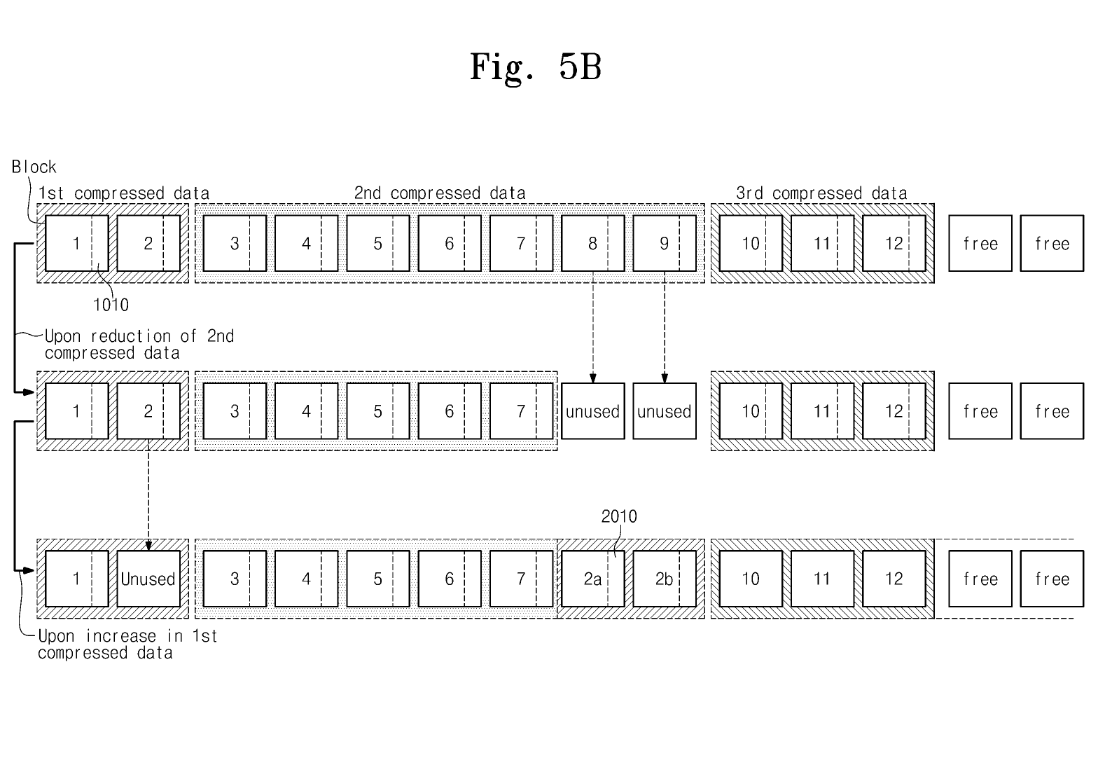

FIG. 5A is a diagram for describing an update operation of a data storage device in which compressed data is stored.

Referring to FIG. 5A, first compressed data is stored in two blocks 1 and 2, second compressed data is stored in seven blocks 3 to 9, and third compressed data is stored in blocks 10, 11, and 12. In each block is stored compressed data according to the above-described manner. That is, each block includes a free/update/remaining space 1010 in addition to the compressed data. If an update operation is requested to reduce the size of the second compressed data by moving or deleting a portion of the second compressed data, then the portion of the second compressed data that is the object of the update request (for example, two blocks 8 and 9) is appointed to an unused block or is assigned an “unused” status. At this time, an erase operation for the unused block is not carried out.

Later, if another update operation is requested to increase the size of the first compressed data, or to add additional data to the first compressed data, it may be determined whether the size of data to be added to the first compressed data is less than or equal to the update region 1010 of the physical storage LWU corresponding to the first and second blocks of the first compressed data.

When the size of update data is less than or equal to the update regions 1010 of the first and second blocks, then the update data may be added to the compressed data of the first and second blocks without re-arranging the compressed data of the first and second blocks. In other words, the data to be added to the compressed data may be stored in a free/update/remaining space 1010 of the block 2 or the blocks 1 and 2, as illustrated in FIG. 5.

On the other hand, as illustrated in FIG. 5B, if the size of the update data is greater than a size of the free/update/remaining space 1010, then the block 2 of the first compressed data may be appointed to an unused block, and two free blocks may be assigned to a log block. New-assigned log blocks are used to update the first compressed data. At this time, data of the block 2 with a free space is moved into a new-assigned log block, and update data is then stored in a remaining space of new-assigned log blocks. For example, in FIG. 5B, the second block of the first compressed data is combined with the update data, and the second block and the update data are stored in previously-unused blocks 2a and 2b. When the first compressed data is combined with the update data, sufficient unused blocks or free blocks may be used such that each resulting block may include an update region 2010 to receive further data updates. Accordingly to an alternative embodiment, the entire first compressed data may be moved to a plurality of blocks having data storage space greater than the first and second blocks.

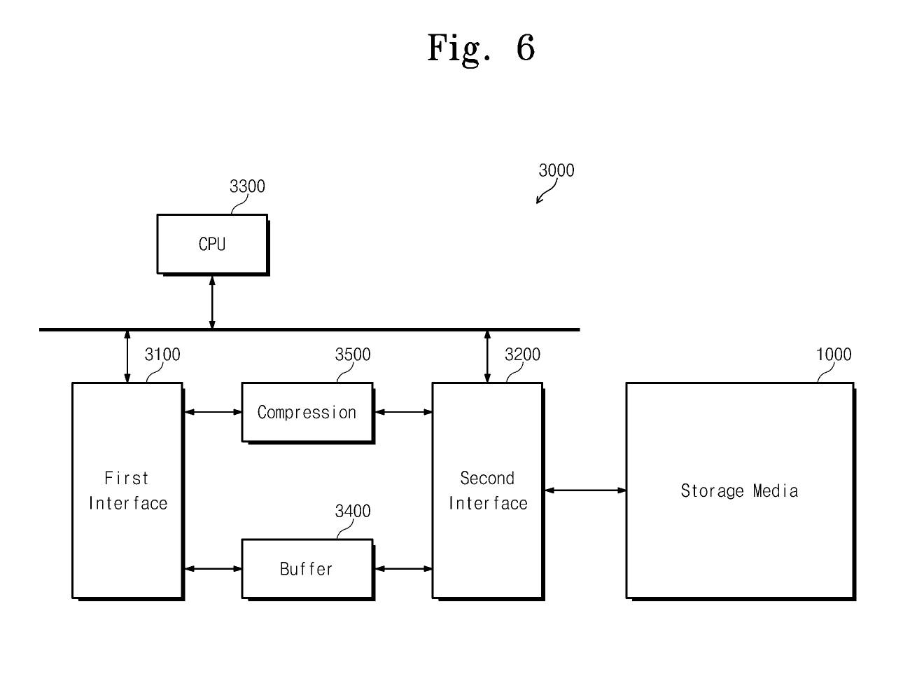

FIG. 6 is a block diagram showing a data storage device according to another exemplary embodiment of the present general inventive concept.

Referring to FIG. 6, a data storage device comprises a storage media 1000 and a controller 3000. The storage media 1000 is configured similarly to that illustrated in FIG. 1. The controller 3000 comprises first and second interfaces 3100 and 3200, CPU 3300, a buffer 3400, and a compression block 3500. The first and second interfaces 3100 and 3200 are similar to the first and second interfaces 2100 and 2200 of FIG. 2, and description thereof is thus omitted. The buffer 3400 is used to transfer data between the first and second interfaces 3100 and 3200 under the control of the CPU 3300. The compression block 3500 is configured to compress data transferred via the first interface 3100 under the control of the CPU 3300 (or, MTL operated by the CPU 3300). In this case, the compression block 3500 may include a buffer for storing data. A unit compressed by the compression block 3500, that is, a division/compression unit of stream data is controlled variably in the same manner as described in FIG. 3.

In an exemplary embodiment, a data storage device is configured such that the compression block 3500 may be turned ON and OFF as needed. For example, the ON/OFF state of the compression block 3500 may be set according to a received stream data. If multimedia data being compressed data is provided to a data storage device, or if a relatively large amount of energy is consumed upon data compression due to a small size of data being compressed, then the compression block 3500 may be set to an OFF state. When the compression block 3500 is disabled, data is transferred to a storage media 1000 via the buffer 3400. Alternatively, externally provided data may be stored directly in the storage media 1000 via the first and second interfaces 3100 and 3200. The ON/OFF state of the compression block 3500 may be set with hardware (for example, a physical register) or via software, such as code stored in memory and executed by a processor. Stream data provided via the first interface 3100 is able to be stored in both the buffer 3400 and a buffer of the compression block 3500. Either one of data in the buffer 3400 and data compressed by the compression block 3500 may be stored in the storage media 1000 according to whether a compression function is activated or inactivated.

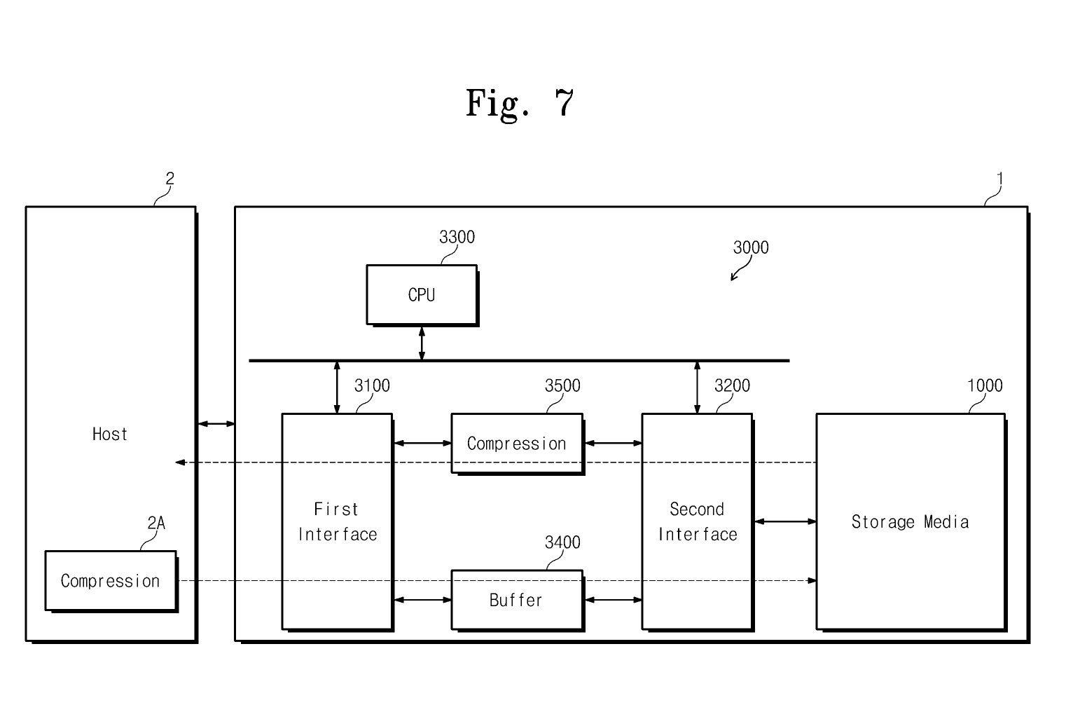

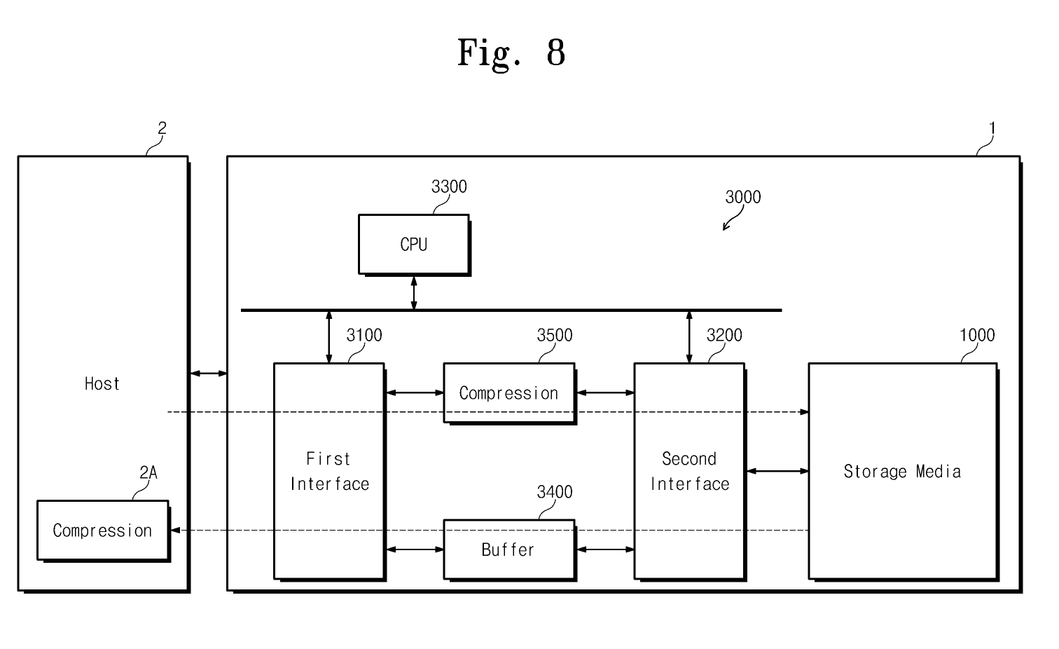

FIGS. 7 and 8 are block diagrams showing systems to which a data storage device according to an exemplary embodiment of the present general inventive concept is applied.

First of all, referring to FIG. 7, a system comprises a data storage device 1 and a host 2. The host 2 comprises a compression block 2A which is configured to compress data to be transferred to the data storage device 1. The data storage device 1 is configured similar to the controller 3000 illustrated in FIG. 6. However, it is well-understood that the controller 2000 in FIG. 2 may also be used as a controller of the data storage device 1 in FIG. 7.

With the above-described system, the host 1 sends data compressed by the compression block 2A to the data storage device 1, and the transferred data is stored in the storage media 1000 via the buffer 3400. In the event that data is transferred to the host 2 from the data storage device 1, compression of data read out from a storage media 1000 is released by a compression block 3500 of the data storage device 1, and decompressed data is sent to the host 2. The same compression algorithm may be applied to the compression blocks 2A and 3500.

On the other hand, as illustrated in FIG. 8, a host 1 may send raw data to a data storage device, and the raw data may be compressed by a compression block 3500. Compressed data is stored in a storage media 1000. In the event that data is transferred to the host 2 from the data storage device 1, data read out from the storage media 1000 is sent to the host 1 via the buffer 3400, and a compression block 2A of the host 1 releases compression of data transferred from the data storage device 1.

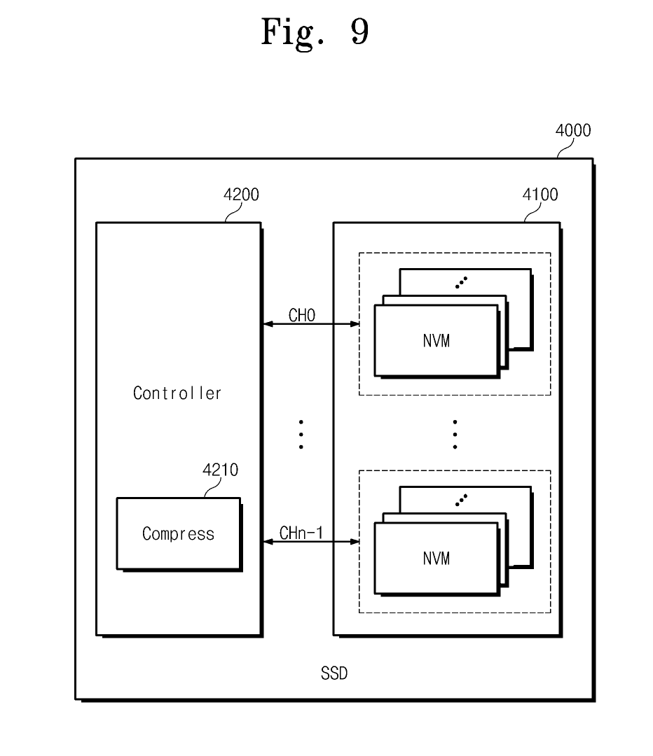

FIG. 9 is a block diagram showing a solid state drive (SSD) to which a compression process according to exemplary embodiments of the present general inventive concept is applied.

Referring to FIG. 9, a solid state drive (SSD) 4000 comprises a storage media 4100 and a controller 4200. The storage media 4100 is connected with the controller 4200 via a plurality of channels, each of which is commonly connected with a plurality of non-volatile memories. The controller 4200 includes a compression block 4210 which is configured to compress data and release data compression.

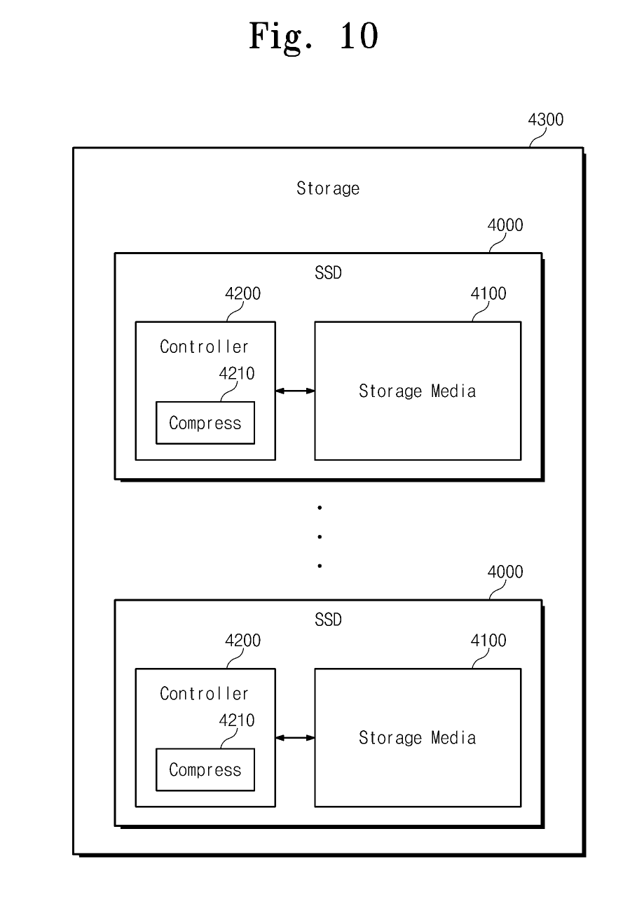

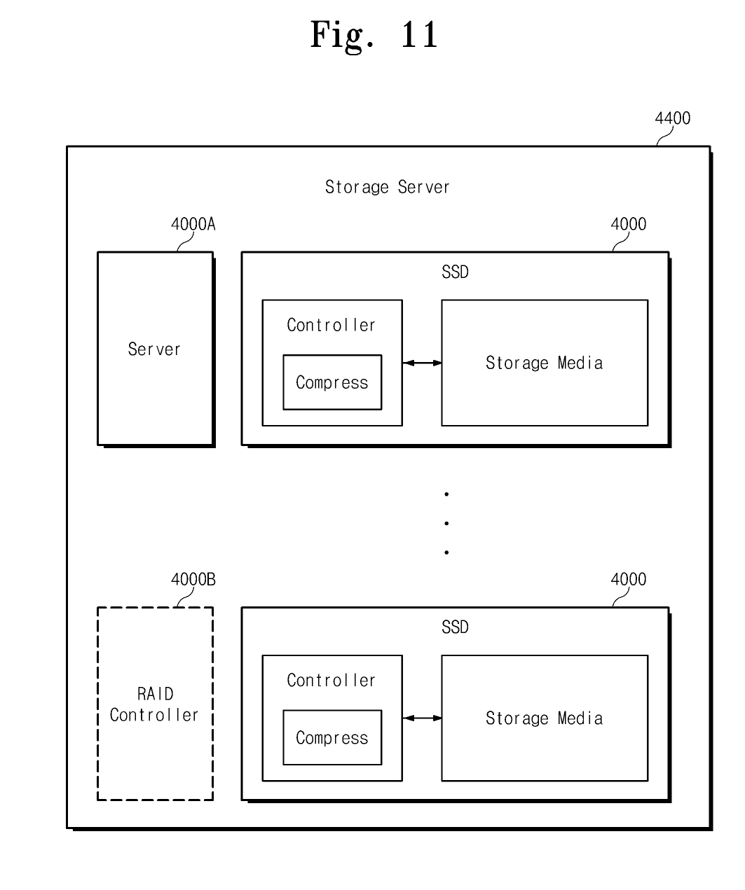

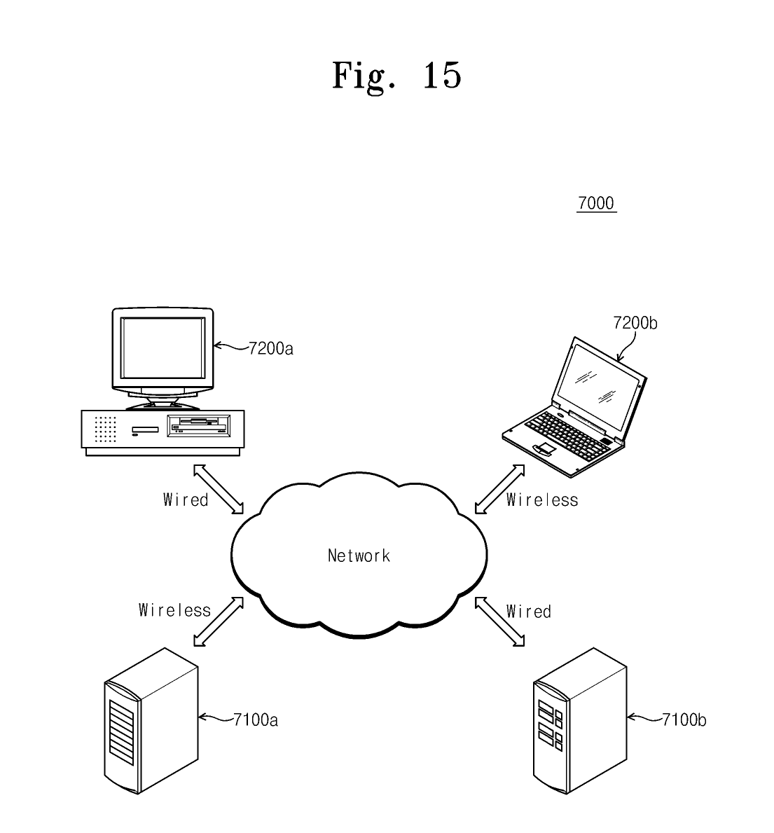

FIG. 10 is a block diagram showing a storage device 4300 using an SSD 4000 illustrated in FIG. 9, and FIG. 11 is a block diagram showing a storage server using an SSD illustrated in FIG. 15.

An SSD 4000 according to an exemplary embodiment of the inventive concept is used to configure a storage. As illustrated in FIG. 10, a storage device 4300 includes a plurality of solid state drives 4000 which are configured the same as described in FIG. 9. An SSD 4000 according to an exemplary embodiment of the present general inventive concept may be used to configure a storage sever. As illustrated in FIG. 11, a storage server 4400 includes a plurality of solid state drives 4000, which are configured the same as described in FIG. 9, and a server unit 4000A. The server unit 4000A controls access to the SSD's 4000. Further, it is well-understood that a well-known RAID controller 4000B may be provided in the storage server 4400.

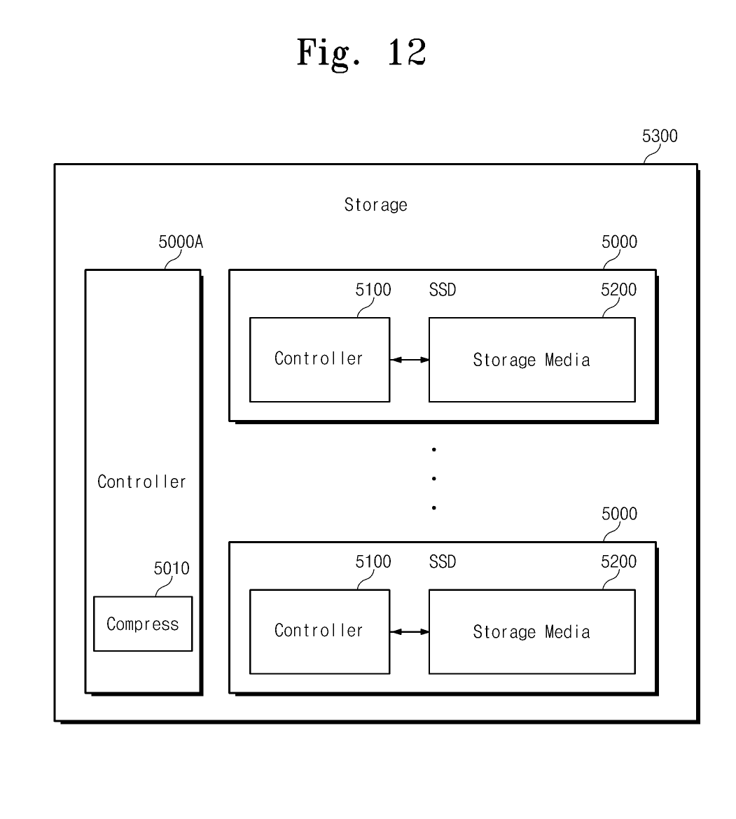

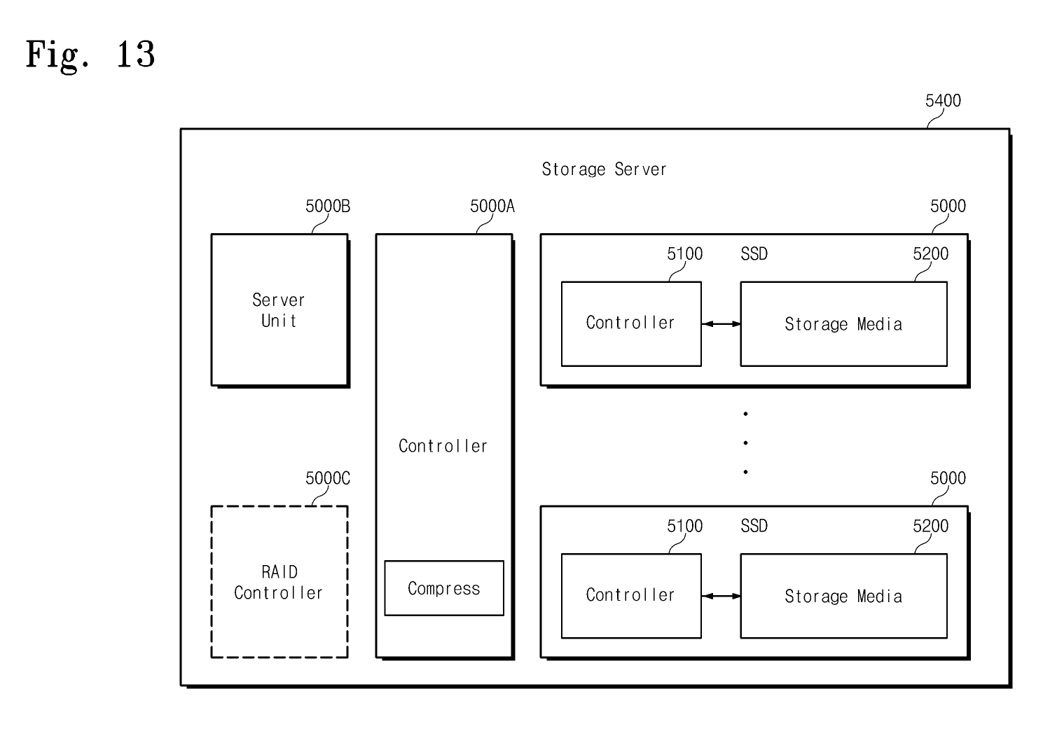

FIG. 12 is a block diagram showing a storage unit 5300 according to another exemplary embodiment of the present general inventive concept, and FIG. 13 is a block diagram showing a storage server 5400 using a storage unit 5300 in FIG. 12.

Referring to FIG. 12, a storage unit 5300 comprises a plurality of solid state drives 5000 and a control block 5000A. Each of the solid state drives 5000 includes a controller 5100 and a storage media 5200. The controller 5100 is configured to perform an interface function with the storage media 5200 and includes a compression unit or compression block 5010. The solid state drives 5000 are controlled by the controller 5000A, which is configured to perform the above-described functions (for example, change of a division size and compression). The storage unit 5300 in FIG. 12 is used to configure a storage server 5400. As illustrated in FIG. 13, a storage server 5400 includes a server unit 5000B and a storage (5000, 5000A) which is configured to be similar to that in FIG. 12. Further, it is well comprehended that a well-known RAID controller 5000C is provided in the storage server.

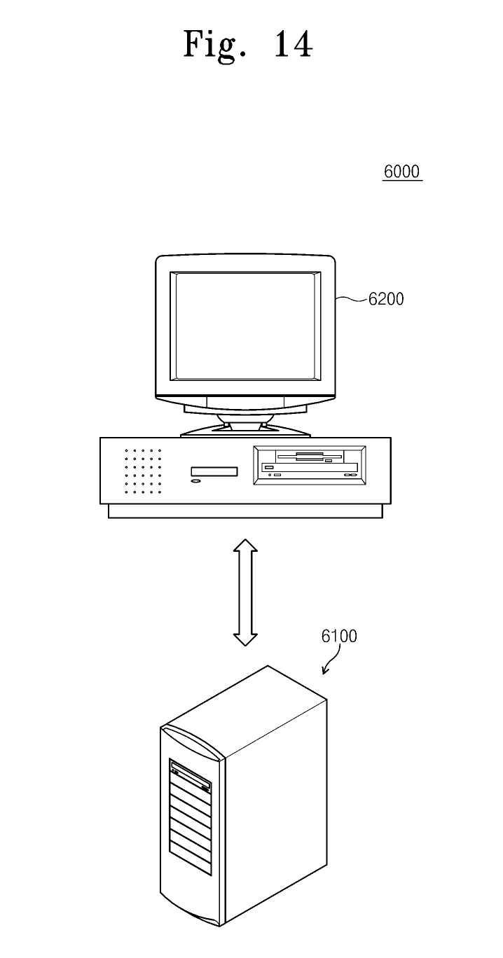

FIGS. 14 to 16 are diagrams showing systems to which a data storage device according to exemplary embodiments of the present general inventive concept is applied.

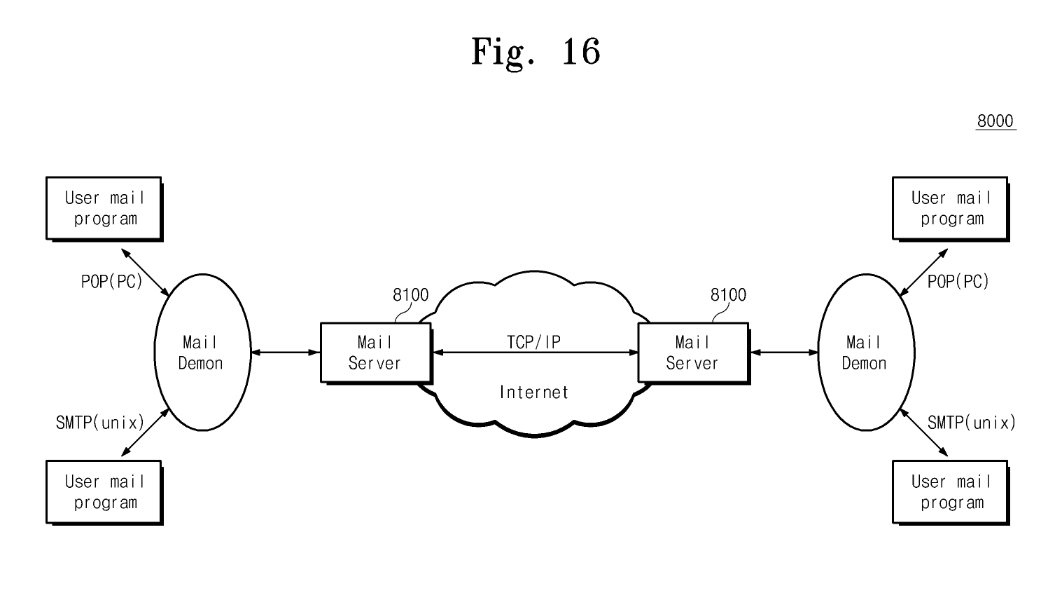

In the event that a solid state drive including a data storage device according to exemplary embodiments of the present general inventive concept is applied to a storage unit, as illustrated in FIG. 14, a system 6000 includes a storage unit 6100 which communicates with a host 6200 by a wire or wirelessly. When the solid state drive including a data storage device according to exemplary embodiments of the present general inventive concept is applied to a storage server, as illustrated in FIG. 15, a system 7000 includes a storage servers 7100a and 7100b which communicate with a host 7200a and 7200b by a wire or wirelessly. Further, as illustrated in FIG. 16, a solid state drive including a data storage device according to exemplary embodiments of the present general inventive concept can be applied to a mail server 8100 and a network system 8000 including the mail server 8100.

In case of a CAD file server which compresses large files and stores compressed data, processes of decompressing a file, updating the decompressed file, and re-compressing the updated file are needed to update only a part of the compressed file. In this case, such processes act as large burden to the CAD file server. For example, decompression, update, and re-compression for a 10 GB file burden a system when updating several kilo bytes of data among the 10 GB data. In case of exemplary embodiments of the present general inventive concept, it is easy to update less information at a server managing large files by controlling a compression unit such that an update region exists at each physical storage unit.

In an exemplary embodiment, a compression block 2500 of a controller 2000 may include one of the following compression algorithms or a combination of two or more compression algorithm. Compression algorithms may includes LZ77&LZ78, LZW, Entropy encoding, Huffman coding, Adpative Huffman coding, Arithmetic coding, DEFLATE, JPEG, etc.

In an exemplary embodiment, a first interface 2100 of a controller 2000 may be formed of one of computer bus standards, storage bus standards, and iFCPPeripheral bus standards, or a combination of two or more standards. The computer bus standards may includes S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, etc. The storage bus standards may include ST-506, ESDI, SMD, Parallel ATA, DMA, SSA, HIPPI, USB MSC, FireWire(1394), Serial ATA, eSATA, SCSI, Parallel SCSI, Serial Attached SCSI, Fibre Channel, iSCSI, SAS, RapidlO, FCIP, etc. The iFCPPeripheral bus standards may include Apple Desktop Bus, HIL, MIDI, Multibus, RS-232, DMX512-A, EIA/RS-422, IEEE-1284, UNI/O, 1-Wire, 12C, SPI, EIA/RS-485, USB, Camera Link, External PCIe, Light Peak, Multidrop Bus, etc.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

Although a few embodiments of the present invention have been shown and described, it would be appreciated by those skilled in the art that changes may be made in these embodiments without departing from the principles and spirit of the general inventive concept, the scope of which is defined in the claims and their equivalents.

What is claimed is:

1. A method of storing data in a storage media, comprising:
compressing raw data based on a physical storage unit of the storage media, the physical storage unit being a predetermined segment of the storage media; and
storing the compressed data such that each of the compressed data and an update region is stored in each physical storage unit of the storage media.

2. The method of claim 1, wherein compressing raw data based on the physical storage unit of the storage media comprises:
dividing the raw data into a plurality of sub-groups based on a compression unit of a predetermined size;
compressing the plurality of sub-groups, respectively; and
adjusting the predetermined size of the compression unit according to whether a size of compressed data of at least one of the plurality of sub-groups satisfies a reference condition.

3. The method of claim 2, wherein the reference condition is determined according to the physical storage unit of the storage media.

4. The method of claim 2, wherein the reference condition a determination whether an update region exists in the physical storage unit of the storage media after compressed data is stored in the physical storage unit of the storage media.

5. The method of claim 2, further comprising, when an update is requested with respect to the physical storage unit of the storage media in which compressed data is stored, judging whether a size of the update region is more than a size of data to be updated.

6. The method of claim 5, wherein when a size of the update region is judged to be more than a size of data to be updated, the data to be updated is stored in the update region of the physical storage unit.

7. The method of claim 5, wherein when a size of the update region is judged to be less than a size of data to be updated, the data to be updated is stored in a new physical storage region of the storage media.

8. The method of claim 2, wherein the storage media comprises at least one non-volatile memory and the physical storage unit corresponds to a block of the non-volatile memory.

9. The method of claim 2, wherein the storage media comprises at least one non-volatile memory and the physical storage unit corresponds to a super-block of the non-volatile memory.

10. The method of claim 2, wherein the storage media comprises at least one non-volatile memory and the physical storage unit corresponds to M blocks of the non-volatile memory (M being an integer of 2 or more).

11. A data storage device comprising:
a storage media; and
a controller configured to compress data to be stored in the storage media in increments of compression units,
wherein the controller controls a size of the compression unit so that an update region exists within a physical storage unit of the storage media in which the compressed data is stored.

12. The data storage device of claim 11, wherein the controller comprises:
CPU;
a buffer operating responsive to the control of the CPU and storing data; and
a compression block operating responsive to the control of the CPU and compressing data in the buffer in increments of compression units.

13. The data storage device of claim 12, wherein a memory translation layer operated by the CPU controls the size of the compression units variably based on whether a size of data compressed by the compression block satisfies a reference condition.

14. The data storage device of claim 13, wherein the reference condition comprises a determination whether an update region exists in the physical storage unit of the storage media after compressed data is stored in the physical storage unit of the storage media.

15. The data storage device of claim 12, wherein the controller selectively activates the compression block according to data to be stored in the storage media, and data received upon inactivation of the compression block is stored in the storage media via the buffer.

16. The data storage device of claim 11, wherein the storage media and the controller constitute a solid state drive.

17. A system comprising:
a plurality of solid state drives,
wherein each of the solid state drives comprises a storage media and a controller configured to compress data to be stored in the storage media in increments of compression units, the controller controlling a size of the compression units so that an update region exists within a physical storage unit of the storage media in which the compressed data is stored.

18. The system of claim 17, wherein the controller comprises a compression block to compress data, and
a memory translation layer operated by the controller controls the compression unit variably based on whether a size of data compressed by the compression block satisfies a reference condition.

19. The system of claim 18, wherein the reference condition comprises a determination whether an update region exists at the physical storage unit of the storage media after compressed data is stored in the physical storage unit of the storage media.

20. The system of claim 17, further comprising a server for providing a server function.

21. A method of storing data, comprising:
detecting a predetermined storage unit of a data storage device, the predetermined storage unit being a segment of data storage of a predetermined size of the data storage device;
determining a compression unit, the compression unit being a predetermined size of compressed data; and
adjusting a size of the compression unit according to a reference condition including a size of the predetermined storage unit of the data storage device.

22. The method of claim 21, wherein the reference condition includes a determination whether the compression unit corresponds to a predetermined percentage of the predetermined storage unit less than 100%.

23. The method of claim 21, wherein the reference condition includes a determination whether the predetermined storage unit is of a sufficient size to include an update region having a predetermined size in addition to the compression unit.

24. The method of claim 21, further comprising:
receiving streamed data;
compressing the streamed data in increments of the compression unit; and
storing the compression units of compressed data in respective predetermined storage units of the data storage device such that each of the predetermined storage units includes an update region to receive additional data.

25. The method of claim 24, further comprising:
after storing the compressed data in the predetermined storage units, receiving an update request to store additional data in at least one predetermined storage unit including the compressed data;
determining whether a size of update data to be stored in the at least one predetermined storage unit in an update operation is equal to or less than a size of the update region of the at least one predetermined storage unit; and
storing the update data in the update region of the at least one predetermined storage unit when it is determined that the size of the update data to be stored in the at least one predetermined storage unit is equal to or less than the size of the update region of the at least one predetermined storage unit.

26. The method of claim 25, further comprising:
storing the compressed data of the at least one predetermined storage unit and the update data in at least a plurality of predetermined storage units having a storage capacity greater than the at least one predetermined storage unit when it is determined that the size of the update data to be stored in the at least one predetermined storage unit is greater than the update region of the at least one predetermined storage unit.

27. A data storage unit, comprising:
a data storage device to store data in increments of predetermined storage units;
a compression device to receive data and to compress the data in increments of compression units; and
a CPU to control the compression device to adjust a size of the compression units based on at least one reference condition including a size of the predetermined storage units.

28. The data storage unit of claim 27, wherein the reference condition includes a determination whether the predetermined storage unit is of a sufficient size to include an update region having a predetermined size in addition to the compression unit.

29. The data storage unit of claim 28, wherein the CPU controls the compression device to compress streamed data in increments of the compression unit and to transmit the compressed data to the data storage device, and
the data storage device stores the compressed data in units of compression units in respective predetermined storage units.

30. The data storage unit of claim 29, wherein the CPU receives an update request to store additional data in at least one predetermined storage unit including the compressed data, the CPU determines whether a size of update data to be stored in the at least one predetermined storage unit in an update operation is equal to or less than a size of the update region of the at least one predetermined storage unit, and the data storage device stores the update data in the update region of the at least one predetermined storage unit when it is determined that the size of the update data to be stored in the at least one predetermined storage unit is equal to or less than the size of the update region of the at least one predetermined storage unit.

31. The data storage unit of claim 30, wherein the data storage device stores the compressed data of the at least one predetermined storage unit and the update data in at least a plurality of predetermined storage units having a storage capacity greater than the at least one predetermined storage unit when it is determined that the size of the update data to be stored in the at least one predetermined storage unit is greater than the update region of the at least one predetermined storage unit.
